(19) United States
(12) Patent Application Publication
(10) Pub. No.: US 2021/0019852 A1
(43) Pub. Date: Jan. 21, 2021

(54) VEHICLE HOURS OF SERVICE ACCOMMODATION FOR AVAILABILITY AND FULFILLMENT PLANNING

(71) Applicant: FORD GLOBAL TECHNOLOGIES, LLC, Dearborn, MI (US)

(72) Inventor: Abraham Mezaael, Southfield, MI (US)

(21) Appl. No.: 16/516,363

(22) Filed: Jul. 19, 2019

(51) Int. Cl. G06Q 50/28; G06Q 10/06

(52) U.S. Cl. CPC G06Q 50/28; G07C 5/04; G06Q 10/06312

(57) ABSTRACT

A cloud-based system may communicate with a plurality of vehicles to receive operating information from the vehicles. The system may also, based on the vehicle operating information, determine if a first vehicle has hours of service (HOS) remaining, within time period over which HOS are legally mandated, sufficient to complete a requested transportation task. The system further adds the first vehicle to an available vehicle list responsive to determining that sufficient HOS for the first vehicle remain. Then the system presents the vehicle list to a requesting, customer and assigns a customer-selected vehicle to completion of the transportation task.

### TECHNICAL HELD

The illustrative embodiments generally relate to methods and apparatuses for using vehicle hours of service for availability and fulfilment planning.

### BACKGROUND

Freight services and ride hailing are both expanding business models that allow independent operators to provide on-demand services for various transportation tasks. In instances, commercial operators are prohibited from operating a vehicle for more than a certain number of hours within a 24 hour period. In traditional fleet models, to which the present concepts could certainly also apply, fleet managers maintain records of fleet usage and can ensure compliance. In independent operator models, however, independent drivers and vehicles may be more relied upon to self-police, which may incentivize drivers to overuse the vehicles in order to complete additional tasks and earn more money.

A consolidation point for drivers, such as an online market for services, may provide available operators for a given task. These systems, however, may also prefer or be required to provide more of a traditional fleet management role in exchange for providing services.

### SUMMARY

In a first illustrative embodiment, a system includes a processor configured to communicate with a plurality of vehicles to receive operating information from the vehicles. The processor is also configured to, based on the vehicle operating information, determine if a first vehicle has hours of service (HOS) remaining, within time period over which HOS are legally mandated, sufficient to complete a requested transportation task. The processor is further configured to add the first vehicle to an available vehicle list responsive to determining that sufficient HOS for the first vehicle remain. Also, the processor is configured to present the vehicle list to a requesting customer and assign a customer-selected vehicle to completion of the transportation task.

In a second illustrative embodiment, a system includes a processor configured to receive hours of service (HOS) reporting from a plurality of vehicles engaged in transportation tasks assigned by the processor, reported at predetermined first intervals. The processor is also configured to determine that at least one first vehicle has passed a predetermined threshold of remaining HOS representing low HOS remaining for a time period over which HOS are legally mandated. Further, the processor is configured to instruct the first vehicle to begin reporting HOS at predetermined second intervals, smaller than the first intervals, until either the time period resets or HOS remaining reaches a predetermined minimum and responsive to the HOS reaching the predetermined minimum, sending an instruction to the first vehicle to begin shut-down.

In a third illustrative embodiment, a method includes determining that the remaining hours of service (HOS), representing legally mandated maximum operational hours over a legally defined time period, for a first vehicle engaged in a transportation task are insufficient for the first vehicle to complete the task within a predefined target time. The method also includes determining a second vehicle, having sufficient HOS remaining to both travel to a predefined meeting point and subsequently complete the task faster than the first vehicle. Further, the method includes determining the predefined meeting point and instructing the first and second vehicles to travel to the predefined meeting point.

### BRIEF DESCRIPTION OF THE DRAWINGS

FIG. 1 shows an illustrative example of a system for handling vehicle and customer connections and vehicle management;

FIG. 2 shows an illustrative communication process between the management system and a vehicle;

FIG. 3 shows illustrative examples of ledger entries;

FIG. 4 shows an illustrative example of a vehicle request process;

FIG. 5 shows an illustrative verification process using the ledger;

FIG. 6 shows an illustrative example of a HOS tracking process; and

FIG. 7 shows an illustrative process for finding alternative delivery options.

### DETAILED DESCRIPTION

As required, detailed embodiments are disclosed herein; it is to be understood, however, that the disclosed embodiments are merely illustrative and may be incorporated in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

Independent operators providing commercial transportation services (for goods or people) may be required to comply with laws designed for safety, such as maximum hours of service (HOS) within a 24 hour period. Because people may not reliably track their own hours, and/or because non-operational delays may not be appropriately accounted for in such self-tracking, it may be easier to use a consolidated system for tracking the HOS of a variety of commercial vehicles. This also can allow for ease in tracking when a given 24 hour period begins and how many hours remain in any given 24 hour period. It can also help customers ensure they are receiving compliant driver offers, and further provide assurances that a transportation goal (e.g., timely delivery) can be met within compliance boundaries by a selected driver.

By using a blockchain ledger, HOS can be tracked in a decentralized and robust model, although this is certainly not the only way to track HOS. A central management system, such as described in example below, can track HOS for a variety of operators while providing ongoing availability for customers. The system can also, when needed, accommodate unexpected changes and arrange for transportation completion based on other available drivers when a planned transportation goal cannot be met.

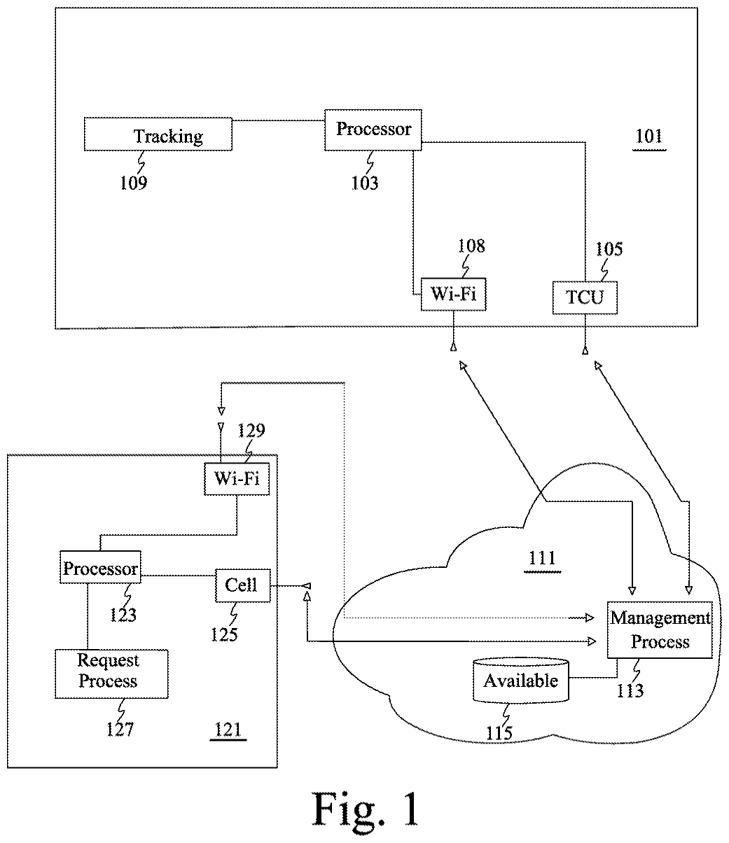

FIG. 1 shows an illustrative example of a system for handling vehicle and customer connections and vehicle management. In this illustrative example, the vehicle 101 includes a carrier vehicle 101, which could be a truck, van, car, etc., and which could be part of a fleet or independently owned and operated.

Freight carrier laws and other commercial driving laws may mandate a certain maximum number of hours of operation per day. Using the illustrative embodiments, this can be tracked with regards to either or both of vehicles and drivers. Tracking this data with regards to drivers can ensure no more than a maximum number of driving hours per day, regardless of vehicle used.

In this example, the vehicle 101 may include at least a processor 103, a telematics control unit (TCU) 105 and an operational tracking program. The driver may be required to log into the operational tracking program in order for the vehicle 101 to start, for example, ensuring that a valid driver ID (for tracking purposes) has been provided in order to use a vehicle 101. Even if driver tracking is not utilized, the vehicle 101 may use the tracking program to track its own operational hours within a window of time.

If the window of time is 24 hours and a vehicle 101 is permitted to be operational within any given 24 hour window for 14 hours, it may help to maintain a record of when the vehicle 101 is operational. If overlapping is permitted, such that the vehicle 101 is permitted to literally continue operating as long as 14 hours is not exceeded within any 24 hour window, it may be very difficult for a person to track this timing (e.g., working 8 hours, then waiting 4 hours, leaves 6 hours remaining, but if the person waits 15 hours, then the time window effectively resets, because the 14 hours will not be exceeded in 24, but the next 5 hours will be within a new 24 hour window and the driver would have been better advised to complete the 5 hours within the previous window if possible).

The math on which hours apply to which window can get complicated, and moreover, even if the windows are literally measured as consecutive windows, drivers may have a difficult time keeping track of when they are permitted to be operating a vehicle 101. Accordingly, onboard 107 and offboard 111 management software may assist in tracking operational hours.

Further, ledgers in a block-chain may track the operational hours (hours of services HOS) for a given group of vehicles 101 in a distributed manner that ensures validity of records and that no vehicle 101 or driver can cheat by altering software or recorded operational characteristics.

The onboard software 107 can maintain tracked hours and report through the TCU 105 or another wireless connection (E.g., 108) to a remote management system 113 in the cloud 111. The management system can also maintain a list of available vehicles 101 that currently have HOS remaining to service requests from customers. The management system 111 can further access the ledger to determine the verified HOS for a given vehicle 101 and/or to update ledger entries to avoid gamesmanship.

Customers can access the management system 113 through remote devices 121, which include cellphones, laptops, desktops, etc. These client-side units include a processor 123, a connection type (cellular 125, Wi-Fi 129, etc) and a service request process 127. Through the service request process 127, the customer can communicate with the management system 113 and receive response to service requests as well as identification of available vehicles 101 to service a request.

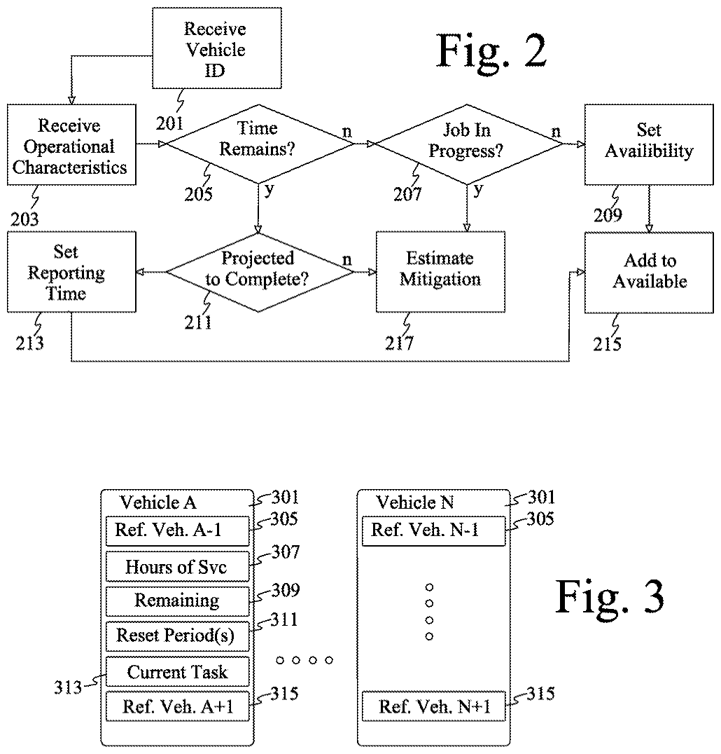

FIG. 2 shows an illustrative communication process between the management system 113 and a vehicle 101. In this example, the system 113 receives a vehicle 101 identifier at 201 in communication from the vehicle 101. This identifies a specific vehicle 101 whose HOS is being tracked and which is otherwise available for service. The system 113 may require reporting periodically and/or can reach out to vehicles 101 periodically either by design or if those vehicles 101 have not reported within an expected time window. For example, the system 113 may require vehicles 101 to report every hour, but if the vehicle 101 is nearing the end of a permissible HOS for a time window, the vehicle 101 may have to report more frequently.

Because the vehicle-side software 107 can shut down the vehicle 101 in some embodiments, the vehicle-side software 107 may also require communication with the management system m the same intervals, and if the communication cannot be established, the software may assume that gamesmanship is occurring and may shut down the vehicle 101 after sonic buffer time period, or almost immediately (as soon as it is safe to do so).

The communication with the system 113 may also include vehicle 101 operational characteristics at 203. This can include, for example, location, projected time remaining, projected HOS remaining, any unexpected deviances, etc. This information can be used by the management system 113 to determine if the vehicle 101 may need any assistance in completing a job or if a shutdown is in order.

If the vehicle 101 still has permissible HOS remaining at 205, the system 113 may determine if the completion of the job is projected to be successful within remaining HOS at 211. This can include a determination of where the vehicle 101 is located, where it is supposed to be located, and how much distance remains for the job vs. how many HOS remain for the vehicle 101.

If the vehicle 101 is out of HOS for the time window (or is nearly out, in some examples) the system 113 may determine at 207 if a job is in progress. If the job is in progress, but no HOS remains for the vehicle 101, the system 113 can engage in mitigation services at 217, which can include, for example, finding another vehicle 101 to complete the task and/or notifying the customer of a delay.

If the vehicle 101 is out of HOS and no job is in progress, the system 113 can set the availability at 219 of the vehicle 101, with a fresh 14 HOS, when the 24 hour window currently in progress expires. This can be confirmed through use of the ledger system, which, if used, helps ensure that no alteration of hours or unexpected vehicle 101 usage occurs.

If the vehicle 101 is expected to complete the task within remaining HOS at 211, the system 113 can set a next reporting time at 213. This could be the standard window of time for reporting, if standard reporting is used, or it could be a new window reflecting diminished HOS for a given vehicle 101 and/or the potential for not completing the job as determined at 211.

If the vehicle 101 is not currently on a job, the system 113 can add the vehicle, with the remaining HOS, to the database 115 for use by other customers.

FIG. 3 shows illustrative examples of ledger entries. These are merely examples of the types of data that could be entered into ledger entries in a blockchain. The entry 301 for vehicle A (which could be recreated every 24 hours or at any other suitable point, and could simply reflect a reporting snapshot whenever the vehicle 101 reports, includes a reference to a preceding entry 305 (usable for verification purposes, i.e., looking up the identified entry should result in an entry pointing back to the present entry) and some operational data about the vehicle 101. This includes, in this example, present. HOS 307, remaining HOS 309, a reset time 311 or times, a current task 313 and a reference 315 to a next ledger entry. The nth ledger entry 303 has similar values pointing both backwards and forwards to entries to preserve the verifiability of the chain.

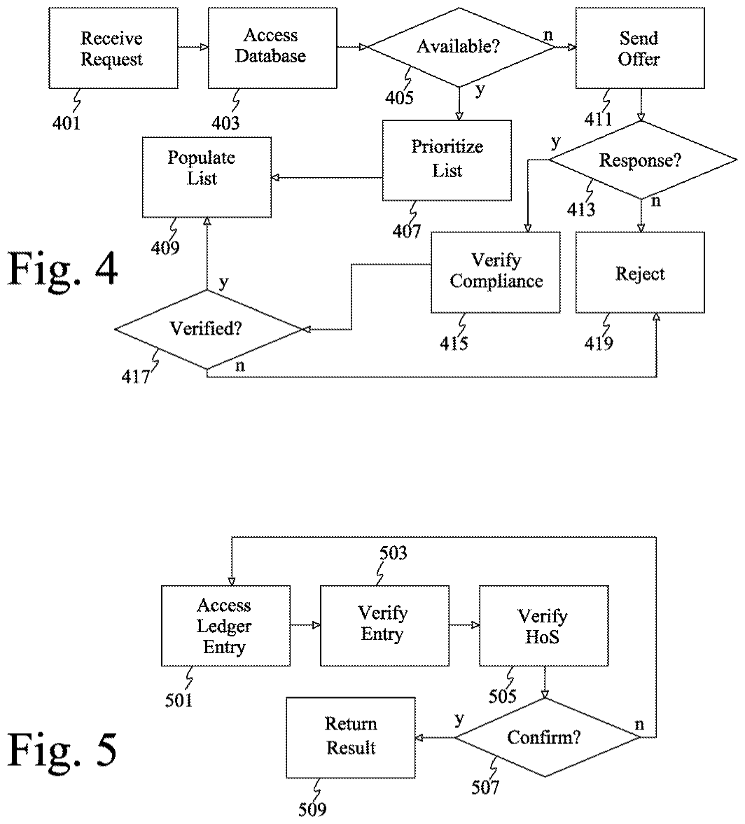

FIG. 4 shows an illustrative example of a vehicle request process, executable by, for example, the management system 113. In this example, the system 113 receives a request for a vehicle to perform a service at 401. Again, these are vehicles 101 that are subject to HOS requirements, so the system 113 accesses the database 115 of available vehicles 101 at 403 to determine which vehicles 101 can meet the pending request.

If there are no vehicles 101 showing as available, based on parameters associated with the vehicles 101 such as, for example, preferred routes, present workloads, costs, etc., the system 113 may send an offer at 411 to various potential vehicles 101 that have at least, for example, a minimum HOS remaining that would allow those vehicles 101 to service the request.

If there are one or more vehicles 101 available at 405, the system 113 may prioritize those vehicles 101 based on predefined parameters or user parameters (cost, capacity, driver rating, etc) at 407 and populate a list 409 that is delivered to the requesting user.

If there is a response to the offer at 413, meaning that at least one driver or vehicle 101 has confirmed willingness to fulfil the request, the system 113 can verify that any responding vehicle 101 is in compliance at 415. Compliance verification can include current HOS, expected remaining HOS based on current vehicle location and request, and whether the request can be completed as requested within the HOS parameters of the responding vehicle 101. If there are no responding vehicles at 413 and/or if there are no verified (at 417) responding vehicles based on the verification at 415, the system 113 will reject the request at 419 and/or queue the request for later servicing if the customer desires. Otherwise, the system 113 populates the list at 409 with any responding, verified vehicles 101 and returns the populated list to the customer.

FIG. 5 shows an illustrative verification process using the ledger. This is another example of a process executable by the system 113, and in this example, the system 113 is attempting to verify that the HOS for a vehicle 101 is accurate and within a tolerance needed for a given task at 501. The system 113 can verify the entry at 503, by using the forward and backward references shown in FIG. 3.

By checking the validity of the forward and backward ledger entries, which both should refer back to the ledger entry of interest, the system 113 verifies that this present ledger entry is, in fact, valid. One the validity of the ledger entry has been verified at 503, the system 113 can also check remaining HOS at 505. The vehicle 101 may have reported the HOS previously, but this allows the system 113 to verify that HOS report based on the ledger. The system 113 may also use a confidence check to verify the ledger entry and if the ledger entry's validity is confirmed at 507, the system can return a result at 509.

If the ledger entry appears to be a false entry, the system 113 can attempt to find the accurate ledger entry by repeating the process, and reporting once a confirmed ledger entry has been found.

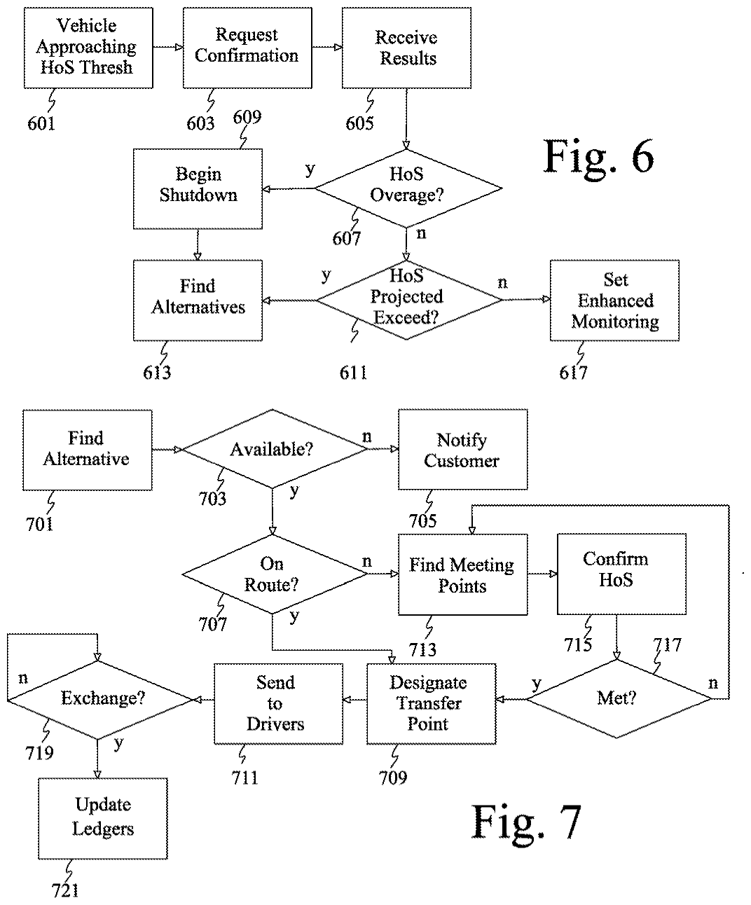

FIG. 6 shows an illustrative example of a HOS tracking process executable by, for example, the system 113. In this example, the system 113 determines that a vehicle 101 may be approaching its HOS threshold for a 24 hour period. For example, if the vehicle 101 last reported 1 hour previously, and it had 2 hours remaining, and it was in service, the system 113 may determine that the vehicle 101 has close to 1 hour remaining in the present period at 601.

The system 113 can request confirmation of the HOS from the vehicle 101 at 603, and/or from a ledger entry depending on when the ledger was updated. After the system 113 receives the results from the request at 605, the system determines if the HOS for the 24 hour window has already been exceeded at 607.

If the HOS are exceeded, i.e., if the vehicle 101 has operated more than a permissible number of hours (or if the HOS is within a threshold of being exceeded (e.g., 10 mins)), the system 113 may order an automatic shutdown of the vehicle 101. This can start with a warning to the driver at 609, and the vehicle 101 is not likely to be immediately disabled regardless of location, but rather will be disabled at a predesignated stopping point delivered to the driver. The driver can drive to the stopping point and the vehicle 101 will shut down, or the vehicle 101 can be disabled at the next stopping point where the vehicle 101 does not present a road-block.

In addition to stopping the vehicle, the system 113 may begin a process to find alternative delivery options at 613 (other vehicles 101) to complete a route that is not completed because of an HOS overage. If the HOS is not exceeded or within a threshold of being exceeded at 607, the system 113 may determine based on present vehicle 101 location and planned route whether the HOS is likely to be exceeded at 611. That is, for example, if the distance remaining and/or traffic conditions and speed limits will cause the vehicle 101 to exceed the HOS hr that vehicle 101, the system 113 may also attempt to find alternative delivery options for completing the route at 613.

If the vehicle's 101 HOS reach a non-zero threshold representing limited HOS remaining, the system 113 may allow the vehicle to complete the mute assuming that a projected route completion time is also below the threshold. That is, if the near-zero threshold is 20 minutes of HOS remaining, but the driver should complete the route in 10 minutes, the system 113 may delay instructing shut-down until either the driver reaches the location or the HOS reaches zero, whichever occurs first.

If the vehicle 101 is likely to complete the task within the remaining HOS, the system 113 may still set enhanced monitoring at 617 to ensure the HOS is not exceeded by, for example, an unexpected delay. This can include increasing the reporting requirements for the vehicle 101 and/or more frequent ledger checks from the system 113 to help ensure compliance and to quickly find an alternative if the vehicle 101 will ultimately fail to complete a route based on remaining HOS.

FIG. 7 shows an illustrative process for finding alternative delivery options, executable by, for example, the system 113. In this example, the system 113 will have already determined that an alternative option is needed for some reason, such as a vehicle 101 being likely to exceed an HOS before completing a route. This may be a planned alternative or a spur of the moment change, and the system 113 can begin the alternative search process at 701 at the appropriate moment (in advance in the former case and immediately in the latter case).

If there is at least one vehicle 101 available at 703, which is a vehicle 101 that can complete a next-leg of a route and which can also meet with a present carrier as well as has sufficient HOS remaining to do both, the process can determine at 707 if that vehicle 101 is presently on a route of its own. Often efficiencies can be had by matching a vehicle 101 already traveling in the correct direction with the HOS-exceeding vehicle, which maximizes HOS usage while avoiding unnecessary detours. If there is no alternative vehicle available at 703, the system 113 may notify the customer that the delivery is going to be delayed at 705.

If there is not a vehicle 101 currently en-route that will serve as the alternative vehicle at 707, the system 113 can find an appropriate meeting point at 713. This can include, for example, a point that fails within the remaining HOS for the current vehicle 101, as well as is on an appropriate path for the new vehicle 101. The system may also confirm that this point will not negatively affect the HOS of either vehicle 101 in a way that will not prohibit the next-segment goal from being achieved at 715, and as long as the HOS for each vehicle 101 can be met, the system 113 can designate a transfer point at 709. This transfer point is the point where the new vehicle 101 can meet the old vehicle 101.

Whether the new vehicle 101 is presently on a route or not, the transfer point is designated in a manner that can preserve necessary HOS for each vehicle 101 to the extent possible. This can require either driver to stop before the other vehicle arrives, if insufficient HOS will otherwise remain. The system 113 sends the transfer point to both drivers at 711 and waits at 719 for an exchange to occur between the vehicles 101 at the transfer point. Once the vehicles 101 have exchanged the loads at the transfer point, the system 113 may update the ledgers at 721 to reflect changes to HOS, routes, loads and availability. The update may also occur when both vehicles are simultaneously present at the meeting point.

The system 113 may also ensure that the new vehicle 101 will have sufficient HOS remaining, to complete the task within the original vehicle's plan, if possible. That is, if the original vehicle was due to complete the task in six hours, the new vehicle will, if possible, have at least six HOS remaining in the next six hours, as opposed to in the next 24 hours. If this parameter cannot be met, the system 113 may still assign the second vehicle if it can complete the task faster than the original (i.e., the original vehicle may have to wait 10 hours before traveling again, whereas the new vehicle may be able to complete the task in eight hours based on HOS management, which is still faster, even if not within the planned six hour time window).

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety and are understood to be examples of types of processes that may be performed to achieve elements of the invention. Additional steps may be added or removed from the exemplary processes as desired.

With respect to the illustrative embodiments described in the figures showing illustrative process flows, it is noted that a general-purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

What is claimed is:

1. A system comprising:
a memory; and
a processor configured to
communicate with a plurality of vehicles to receive operating information from the vehicles for storage in the memory;
based on the operating information stored to the memory, determine if a first vehicle has hours of service (HOS) remaining, within a time period over which HOS are legally mandated, sufficient to complete a requested transportation task;
add the first vehicle to an available vehicle list responsive to determining that sufficient HOS for the first vehicle remain;
present the vehicle list to a requesting customer; and
assign a customer-selected vehicle to completion of the transportation task.

2. The system of claim 1, wherein the operating information includes a present task in which the vehicle is engaged, defined by at least a destination.

3. The system of claim 1, wherein the operating information includes a vehicle-determined calculation of present HOS within a present time period over which HOS are legally limited.

4. The system of claim 1, wherein the processor is further configured to:
receive updated HOS remaining for the assigned vehicle within the time period while the assigned vehicle is completing the task;
determine that insufficient HOS remain to complete the task within the time period based on the updated HOS; and
responsive to insufficient HOS remaining, instruct a second vehicle to meet the assigned vehicle at a predetermined location so that the second vehicle can complete the task.

5. The system of claim 4, wherein the updated HOS are received from the vehicle.

6. The system of claim 4, wherein the updated HOS are received from a ledger entry in a block-chain responsive to a request from the processor.

7. The system of claim 4, wherein the processor is configured to determine that insufficient HOS remain based on an identified remaining route to complete the task combined with identified speed limits for the remaining route.

8. The system of claim 4, wherein the processor is configured to determine that insufficient HOS remain based on an identified remaining route to complete the task combined with identified traffic congestion for the remaining route.

9. The system of claim 4, wherein the processor is configured to determine that the second vehicle will have sufficient HOS remaining to complete the task within the time period, following meeting the assigned vehicle at the predetermined location.

10. The system of claim 4, wherein the processor is configured to determine the second location as a location reachable by the assigned vehicle without the assigned vehicle exceeding remaining HOS.

11. A system comprising:
a processor configured to:
receive hours of service (HOS) reporting from a plurality of vehicles engaged in transportation tasks assigned by the processor, reported at predetermined first intervals;
determine that at least one first vehicle has passed a predetermined threshold of remaining HOS representing low HOS remaining for a time period over which HOS are legally mandated;
instruct the first vehicle to begin reporting HOS at predetermined second intervals, smaller than the first intervals, until either the time period resets or HOS remaining reaches a predetermined minimum; and
responsive to the HOS reaching the predetermined minimum, sending an instruction to the first vehicle to begin shut-down.

12. The system of claim 11, wherein the instruction to the vehicle includes a driver notification that shutdown is imminent.

13. The system of claim 11, wherein the instruction to the vehicle includes identification of a location where a driver should drive the vehicle for shutdown.

14. The system of claim 11, wherein responsive to the predetermined minimum being non-zero and a projected travel time for a remaining route being less than the minimum, the processor is configured to delay sending the instruction for shut-down until either the HOS reaches zero or the, vehicle reaches a destination of the remaining route.

15. The system of claim 11, wherein the processor is further configured to verify received HOS for a given vehicle based on a ledger entry in a block-chain, the ledger entry including a previously recorded and verified HOS value for the given vehicle.

16. A method comprising:
determining that the remaining hours of service (HOS), representing legally mandated maximum operational hours over a legally defined time period, for a first vehicle engaged in a transportation task are insufficient for the first vehicle to complete the task within a predefined target time;
determining a second vehicle, having sufficient HOS remaining to both travel to a predefined meeting point and subsequently complete the task faster than the first vehicle;
determining the predefined meeting point; and
instructing the first and second vehicles to travel to the predefined meeting point.

17. The method of claim 16, wherein the determining the second vehicle has sufficient HOS remaining includes determining that the second vehicle has sufficient HOS remaining to complete the task within the target time.

18. The method of claim 16, wherein the determining the second vehicle has sufficient HOS remaining includes determining that the second vehicle has insufficient HOS remaining to complete the task within the target time, but will reset HOS faster than the first vehicle, based on each vehicle's point within the legally defined time period for present HOS, thus allowing the second vehicle to complete the task faster than the first vehicle based on an earlier reset or the HOS for the second vehicle.

19. The method of claim 16, wherein the determining the meeting point further includes determining a meeting point reachable by the first vehicle without the first vehicle exceeding remaining HOS.

20. The method of claim 16, further comprising updating a ledger entry in a block-chain, the entry including both a task and present HOS for over present measure of the legally mandated time period, such that the ledger entry for the second vehicle reflects the HOS remaining for the second vehicle and the task taken over by the second vehicle from the first vehicle, the updating responsive to receiving confirmation that both the first and second vehicles are simultaneously at the predefined meeting point.
